(19) United States
(12) Patent Application Publication
(10) Pub. No.: US 2011/0173880 A1
(43) Pub. Date: Jul. 21, 2011

(54) Maple syrup line system with increased diameter lines and fittings

(75) Inventor: Timothy D. Perkins, Richmond, VT (US)

(73) Assignee: UNIVERSITY OF VERMONT AND STATE AGRICULTURAL COLLEGE

(21) Appl. No.: 12/657,333

(22) Filed: Jan. 19, 2010

(51) Int. Cl. A01G 23/14

(52) U.S. Cl. 47/52; 47/58.1 R

(57) ABSTRACT

A line system for a maple syrup production system, where the lateral lines have an inside diameter greater than 5/16″ nominal and less than or equal to ¾″ and the lateral line fitting and mainline fitting have a nominal inside diameter of greater than 0.225″ and less than or equal to 0.70″. Further, the line system has drop lines with an inside diameter greater than 5/16″ nominal and less than or equal to ¾″ and the spout fitting has a nominal inside diameter of greater than 0.225″ and less than or equal to 0.70″. The increased inside diameters of the drop lines, lateral lines, spout fittings, lateral line fittings and mainline fittings dramatically improves the flow of air and sap from the taphole and through the line system.

### CROSS-REFERENCE TO RELATED APPLICATIONS

The present application is also related to U.S. patent application Ser. No. ______, entitled “Maple spout with interior chamber and maple syrup production system using same,” and U.S. patent application Ser. No. ______, entitled “Dual-line spout and maple syrup production system using same,” both filed Jan. 19, 2010, the same day as the present application, and which applications are incorporated by reference herein.

### FIELD OF THE INVENTION

The present invention relates generally to maple syrup production, and in particular relates to a line system having increased diameter lines and fittings.

### BACKGROUND ART

Maple syrup production involves drilling holes into (i.e., “tapping”) maple trees, collecting the sap that exudes from the wound, and then reducing or “sugaring” down the sap using reverse osmosis and evaporators to form the final syrup. Details of maple syrup production are described in the publication entitled “North American Maple Syrup Producers Manual” (second edition), produced by Ohio State University, in cooperation with the North American Maple Syrup Council, and edited by Heiligmann, Koelling and Perkins, which is incorporated by reference herein by way of background information.

The traditional way of collecting maple sap uses buckets at the tap source. The sap is then collected in a tank and then transported to the “sugarhouse” for processing. Over the years, a variety of specialized hardware has been developed for this task, including both sap spouts (also called “maple syrup spouts”) and specialized sap collection buckets or bags. For many years, however, the basic techniques of maple syrup and sugar production remained essentially unchanged.

More recently, modern syrup producers have replaced the traditional bucket collection system with a tubing system that includes special spouts (usually 19/64″, 5/16″ or 7/16″ outside diameter) and plastic tubing “droplines” (usually 5/16″ inside diameter and about 18″ to 36″ in length) connected to the various spouts. The droplines are then connected to lateral lines (also usually formed from 5/16″ inside-diameter plastic tubing) that run between different maple trees. The lateral lines are in turn connected to one or more “main lines” (usually ¾″ to 2″ diameter) that run to the sugar house. Such systems are described in, for example, U.S. Pat. Nos. 2,877,601, 2,944,369, 3,046,698, and 3,057,115, and may either be gravity fed or utilize a vacuum pump to move the sap to a central collection point (e.g., an evaporator in the sugarhouse).

The sap flows from the tree through the spout and then through the line system when the pressure within the tree is greater than that in the lines. The line system then eventually conveys the sap to the evaporator. To facilitate the extraction and transportation of the sap from the tree and to the evaporator, some systems use a pump to pull a vacuum within the line system. This increases the pressure differential between the inside of the line system and the tree, thereby increasing the volume of sap flow as compared to that which would naturally occur by gravity.

The use of 5/16″ and ¼″ drop lines and lateral lines and the associated fittings is based in part on the fact that such tubing and fittings have always been readily available due to its uses in other industries such as the medical industry. Also, under gravity flow, when the lateral lines are full of liquid (sap), there is a natural vacuum that develops in the line that pulls on the taphole. Thus under gravity flow conditions, having lateral lines full of sap was beneficial in achieving higher yields.

However, with vacuum-based maple syrup production systems there are higher volumes of sap flow though the line system. In addition, air needs to move through the line system, with the goal being to maximize vacuum transfer from the vacuum pump to the taphole. Because existing lines do not transfer the vacuum efficiently when filled with liquid, the response in the industry has been to decrease the number of taps per lateral line, which is restrictive and costly.

### SUMMARY OF THE INVENTION

An aspect of the invention is a line system for a maple syrup production system having a mainline. The line system includes at least one spout having a spout fitting and at least one lateral line fluidly connected to the main line via a mainline fitting. The line system also includes at least one dropline fluidly connected at one end to the spout fitting and at another end to the lateral line at a lateral-line fitting. At least one lateral line has an inside diameter greater than 5/16″ nominal and less than or equal to ¾″, and the lateral line fitting and mainline fitting have a nominal inside diameter of greater than 0.225″ and less than or equal to 0.70″.

Another aspect of the invention is a line system for a maple syrup production system having a mainline. The line system includes at least one spout having a spout fitting, and at least one lateral line fluidly connected to the main line via a mainline fitting. The line system also includes at least one dropline fluidly connected at one end to the spout fitting and at another end to the lateral line at a lateral-line fitting. The at least one drop line has an inside diameter greater than 5/16″ nominal and less than or equal to ¾″ and the lateral line fitting and spout fitting have a nominal inside diameter of greater than 0.225″ and less than or equal to 0.70″.

Another aspect of the invention is a method of conveying sap from a taphole in a maple tree through a line system having a mainline attached to a vacuum system. The method includes inserting a spout into the taphole, with the spout having a spout fitting and fluidly connecting a dropline to the spout fitting. The method also includes fluidly connecting the dropline to a lateral line via a lateral line fitting and fluidly connecting the lateral line to the mainline via a mainline fitting. The method further includes providing the lateral line with an inside diameter greater than 5/16″ nominal and less than or equal to ¾″, and providing the lateral line fitting and mainline fitting with a nominal inside diameter of greater than 0.225″ and less than or equal to 0.70″. The method also includes applying a vacuum to the line system.

Another aspect of the invention is a method of conveying sap from a taphole in a maple tree through a line system having a mainline attached to a vacuum system. The method includes inserting a spout into the taphole, with the spout having a spout fitting, and fluidly connecting a dropline to the spout fitting. The method also includes fluidly connecting the dropline to a lateral line via a lateral line fitting, and fluidly connecting the lateral line to the mainline via a mainline fitting. The method also includes providing the drop line with an inside diameter greater than 5/16″ nominal and less than or equal to ¾″, and providing the lateral line fitting and spout fitting with a nominal inside diameter of greater than 0.225″ and less than or equal to 0.70″.

Additional features and advantages of the invention are set forth in the detailed description that follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagrams of a vacuum-based maple syrup production system that uses the line system of the present invention;

FIGS. 2A through 2E are diagrams of example spouts for use in the line system of the present invention;

FIG. 3 is a plot of the pressure (head) loss (in feet) versus the line inside diameter D_{IN} (in inches);

FIG. 4A and FIG. 4B are cross-sectional diagrams of the inside diameters D_{IN} of an increased diameter drop line (FIG. 4A) and an increased diameter lateral line (FIG. 4B);

FIG. 5 is a schematic diagram of an example line system where the lateral lines, lateral line fittings, and mainline fittings have an increased inside diameter while the spout fittings, drop lines and the mainline have a conventional inside diameter;

FIG. 6 is similar to FIG. 5, except that the line system further includes drop lines and spout fittings having an increased inside diameter; and

FIG. 7 is similar to FIG. 6, except that mainlines are used in place of lateral lines and mainline fittings, drop lines and spout fittings have an increased inside diameter.

### DETAILED DESCRIPTION OF INVENTION

In the description below, the term “fluidly connected” generally includes techniques known in the art of maple syrup production to connect fluid-carrying parts of the production system so that fluid can flow between or through the parts. An exemplary fluid connection technique is a “press fit,” where the end of one part (e.g., a drop line 210, described below) is slid over and pressed onto the end of another part (e.g., a spout fitting 16 with ridges 18, as described below) to provide a snug fit that is water-tight and vacuum tight. Other fluid connection techniques that are available employ threaded parts or snap-fit parts.

Also in the discussion below, primes on reference numbers are used in certain cases to denote a line system component (such as a line or fitting) having an increased inside diameter.

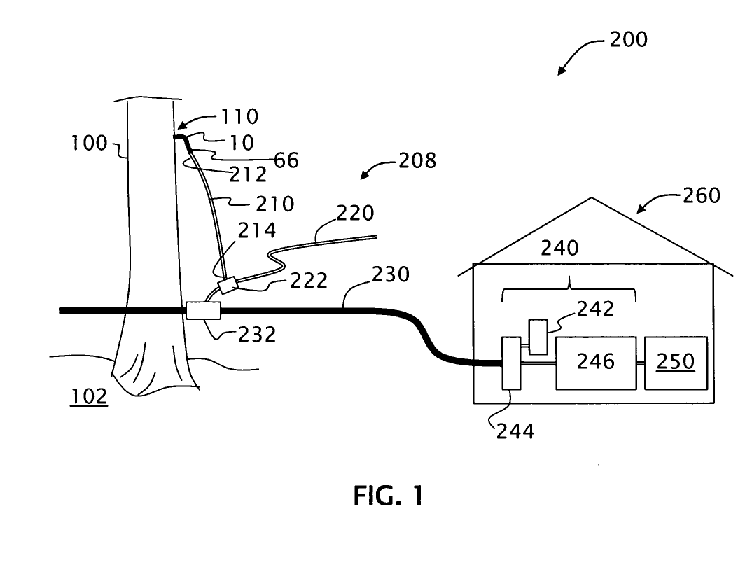

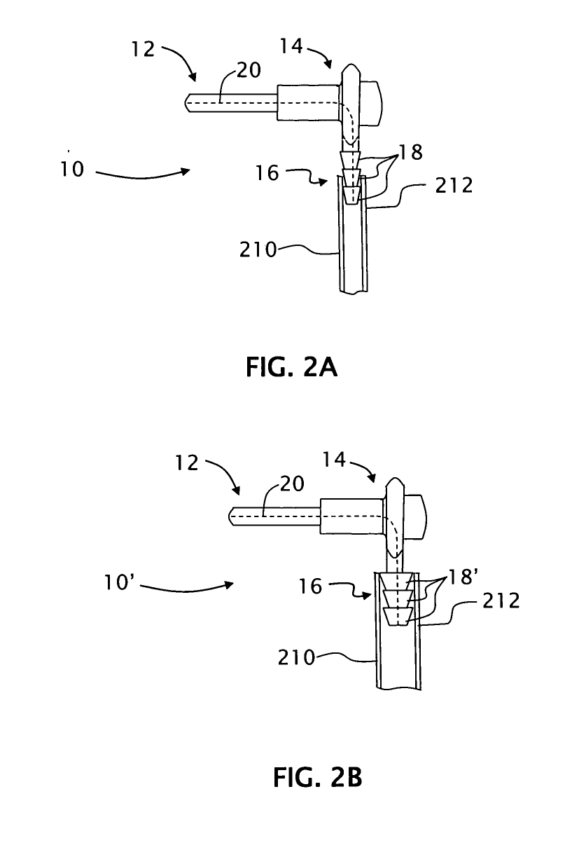

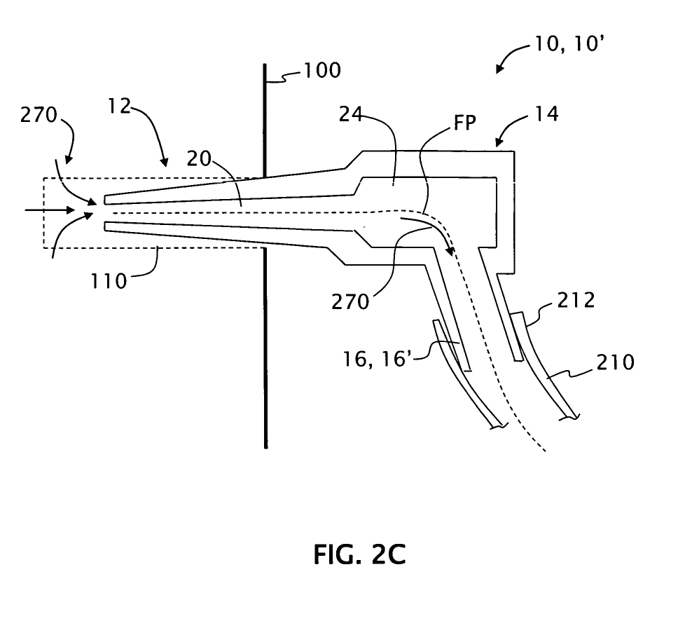

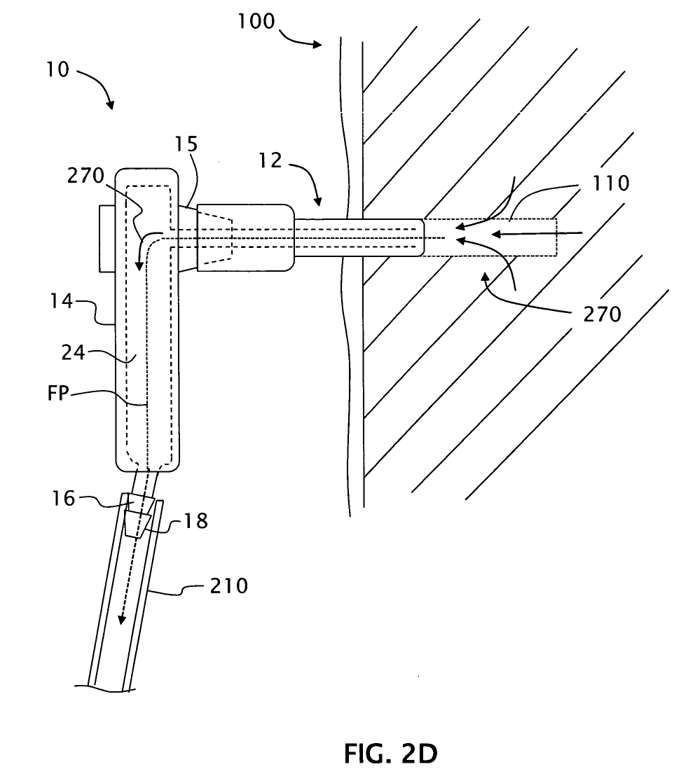

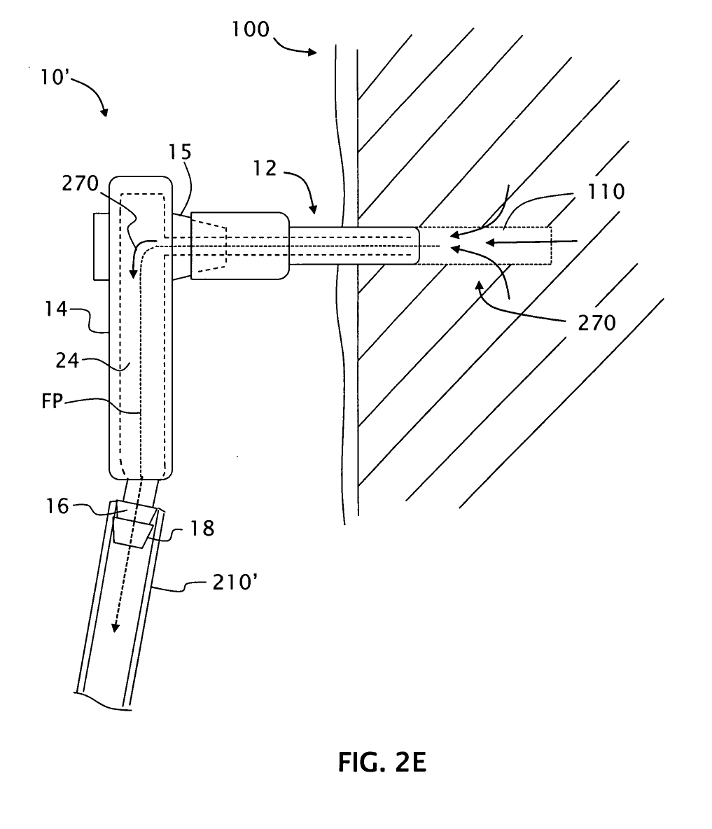

FIG. 1 is a schematic diagram of an example maple syrup production system 200 that includes a maple syrup spout (“spout”) 10 connected to tree 100 at a taphole 110 formed therein. Example spouts 10 are shown in FIGS. 2A through 2D. Spout 10 has a nose section 12 adapted to fit into taphole 110, a main body portion 14, and an output end 16 having ridges 18 used to form a press fit with end 212 of dropline 210. Spout 10 includes an internal channel 20 that fluidly connects nose section 12 to output end 16.

One example spout 10 is described in U.S. patent application Ser. No. 12/286,032, which is incorporated by reference herein. Output end 16 constitutes a “spout fitting” for dropline 210. The example spouts 10 of FIGS. 2C through 2E include an internal cavity 24. Spouts 10 of FIGS. 2D and 2E have a removable nose section 12 that press-fits onto a nose adapter portion 15 of main spout body 14. The spouts of FIGS. 2A and 2B are the same spout but with the spout 10′ of FIG. 2B having an increased-diameter spout fitting 16′ as compared to the spout fitting 16 of spout 10 of FIG. 2A. Likewise, the spouts of FIGS. 2D and 2E are the same spout but with the spout 10′ of FIG. 2E having an increased diameter spout fitting 16′ as compared to that of FIG. 2D. The spout of FIG. 2C can have a standard spout fitting 16 or an increased inside-diameter spout fitting 16′.

System 200 includes a line system 208 that includes aforementioned dropline 210, a lateral line 220 and a mainline 230. A first end 212 of a dropline 210 is fluidly connected to an output end 66 of spout 10 while the other end 214 is fluidly connected to lateral line 220 at a lateral-line connector (“lateral line fitting”) 222 (FIG. 2), such as a “T” connector.

Lateral line 220 in turn is operably (i.e., fluidly) connected to mainline 230 at a mainline fitting 232, such as a “saddle” connector. Mainline 230 is in turn is operably connected to vacuum pump system 240 that includes a vacuum pump 242, an extractor 244 and a sap storage tank 246. An evaporator 250 is operably connected to vacuum pump system 240. Vacuum pump system 240, extractor 244, storage tank 246 and evaporator 250 are shown as housed in a sugarhouse 260.

System 200 thereby provides vacuum-assisted fluid communication between taphole 110 and evaporator 250 so that sap can flow from tree 100 to the evaporator. It is noted here that “fluid communication” refers to both the sap as a fluid and the air in the line system as a “fluid.” Said differently, line system 208 is sufficiently air-tight so that vacuum system 240 can pull a sufficient vacuum (e.g., 15-28 inches of mercury).

The line system 208 of the present invention includes embodiments wherein at least one of the drop lines 210 and the lateral lines 220 has an inside diameter D_{I} of greater than 5/16″ (nominal) up to ¾″, or alternatively up to ½″. Here, the phrase “nominal” is meant to account for manufacturing variations in the inside diameter of what is intended to be lines having a specified diameter, such as 5/16″. Manufacturing variations in the inside diameter of 5/16″ lines can be up to about 2.5%, so that the ‘ 5/16″ nominal’ inside diameter (i.e., 0.3215 “) can in some cases be as large as about 0.33” or as small as 0.314″. Likewise, in certain embodiments, the spout fitting 16, the lateral line fitting 222 and the mainline fitting 232 have increased inside diameters that range from being greater than 0.225″ and less than or equal to 0.70″.

The primary benefit of a line system 208 having at least some of the lines and fitting with an increased inside diameter as compared to the lines used in conventional line systems is to provide a more efficient flow path for sap 270 to move downhill, and for air to similarly move downhill (i.e., for vacuum to be transferred up to taphole 110), but to lessen the turbulence and associated friction associated with the air and sap flow in the lines.

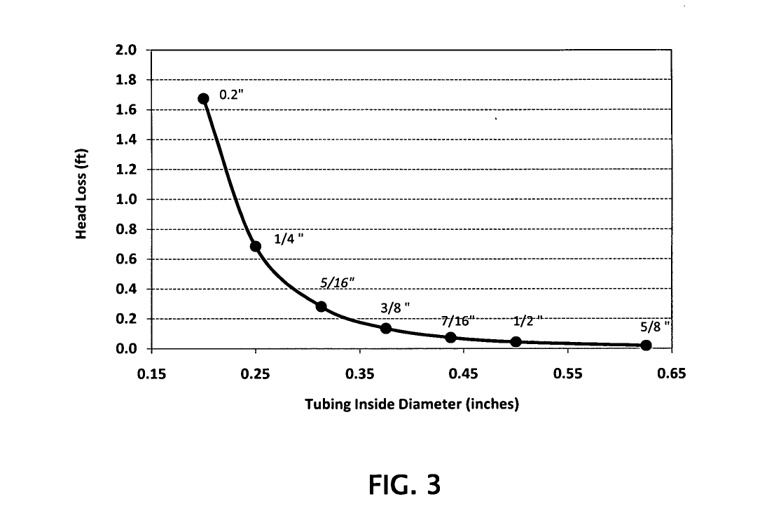

FIG. 3 is a plot of the pressure (head) loss (in feet) versus the line inside diameter in inches. The plot is based on a 100′ lateral line with 10 taps and at the maximum sap flow rate. Head loss that occurs in pipes is dependent on the flow velocity, the pipe length, pipe inside diameter, and a friction factor based on the roughness of the pipe and the Reynolds number of the flow. From the plot, it is seen that the smaller the line inside diameter, the greater the head loss due to friction in the line.

The nominal inside diameter of conventional lateral lines and drop lines is 5/16″. However, fittings typically go inside of such lines to accommodate a press fit fluid connection. This reduces the functional inside diameter of that part of the line system to ¼″ or less. This inside diameter is at the steepest part of the head-loss curve, meaning that the head losses increase quickly with decreasing line size, but decrease quickly with increasing line size. Increasing the line inside diameter to ½″ decreases the head loss by about a factor of 14×, while increasing the line inside diameter to ¾″ decreases the head loss by about a factor of 35×.

Note also that increasing the fitting inside diameter from 0.20″ to 0.375″ decreases heat loss by a factor of 12×.

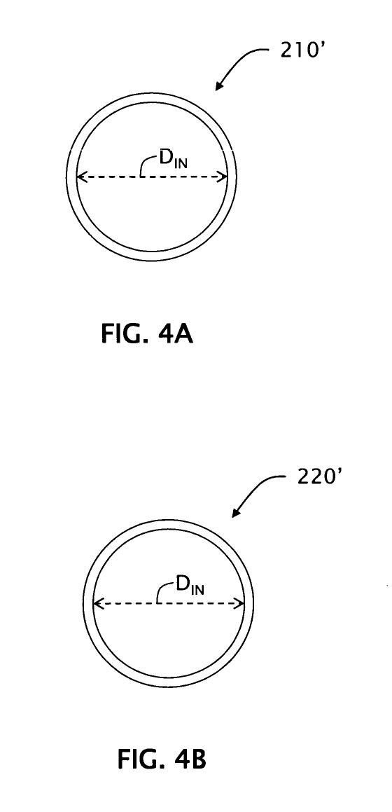

FIG. 4A and FIG. 4B are cross-sectional diagrams of the inside diameters D_{IN} of an increased diameter drop line 210′ (FIG. 4A) and an increased diameter lateral line 220′ (FIG. 4B).

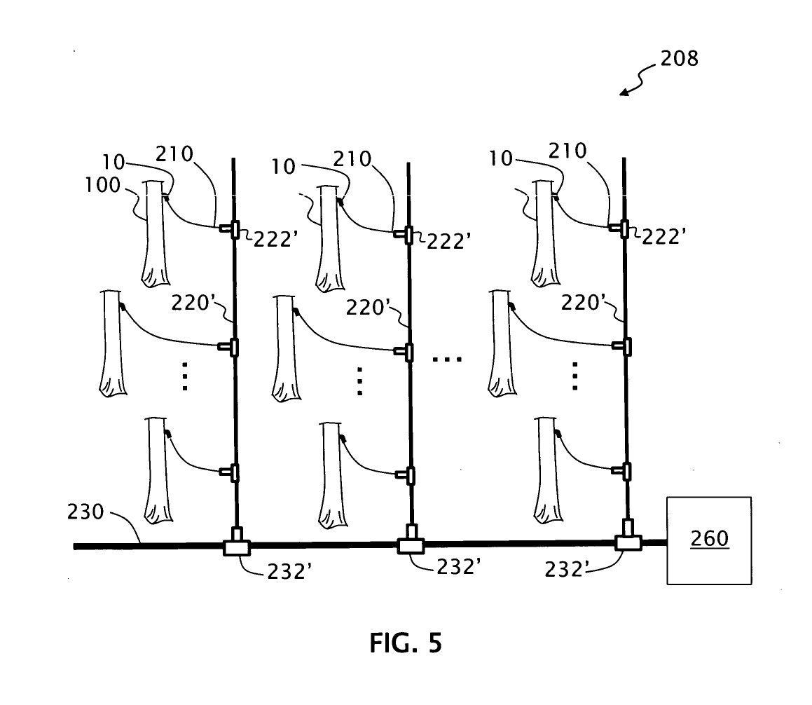

FIG. 5 is a schematic diagram of an example line system 208 according to the present invention, where lateral lines 220′, lateral line fittings 222′ and mainline fittings 232′ have an increased inside diameter D_{I} (and are thus identified as 220′), while the drop lines 210 and spout fittings 216 have a conventional inside diameter, i.e., 5/16″ or smaller, and the mainline 230 has a conventional inside diameter (e.g., 2″). In this particular example embodiment, lateral line fittings 222′ and main line fittings 232′ also have an increased inside diameter to accommodate the larger lateral line. This embodiment allows for conventional spouts 10 to be used while also providing greater sap transportation efficiency.

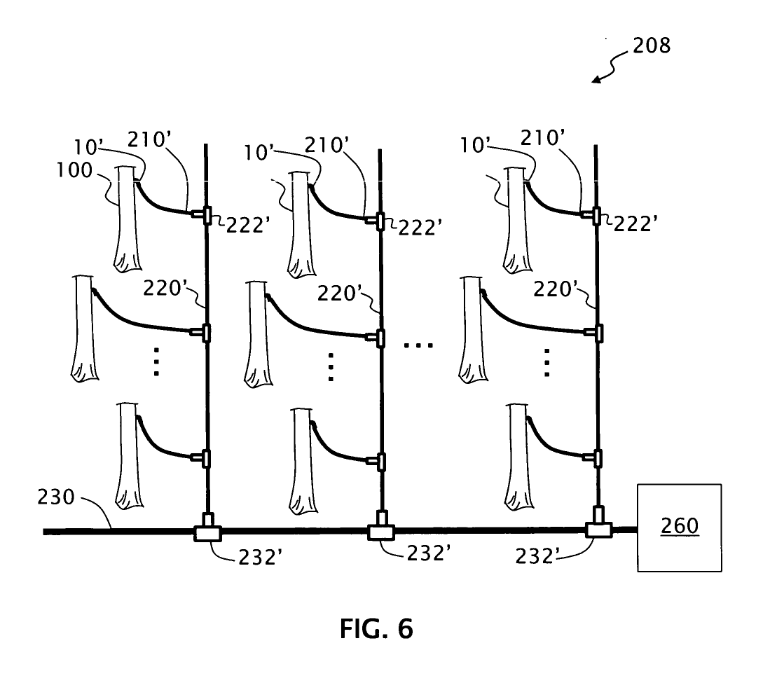

FIG. 6 is similar to FIG. 5 and illustrates another example embodiment of line system 208 wherein the lateral lines 220′ and drop lines 210 have an increased inside diameter. In this particular example embodiment, line system 208 also includes lateral line fittings 222′, mainline fittings 232′, and spout fittings 16′ of spout 10′ (FIG. 3B) with increased diameter to accommodate the larger drop lines and lateral lines.

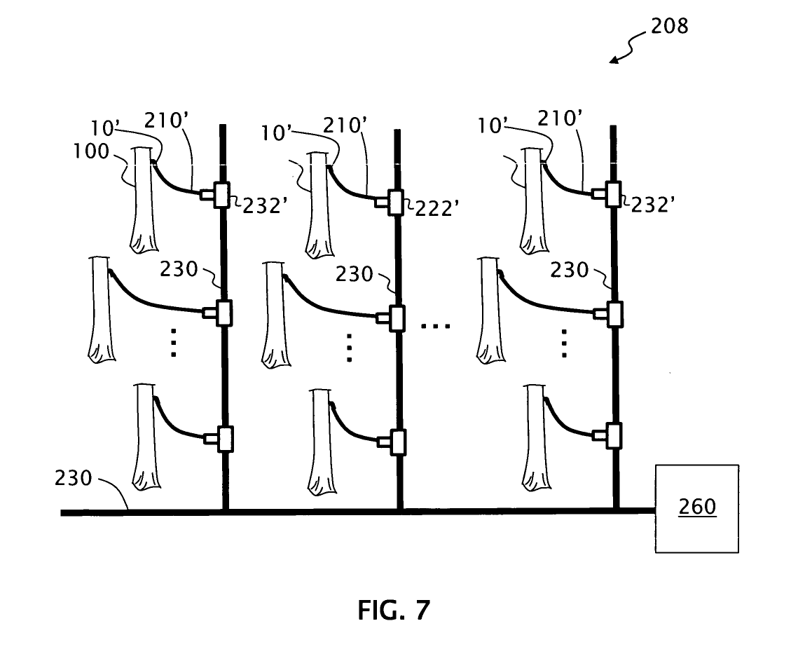

FIG. 7 is similar to FIG. 6 and illustrates another example embodiment of line system 208 where mainlines 230 are substituted for lateral lines 220 or 220′ and mainline fittings 232′ are substituted for lateral line fittings 222′. Droplines 210′ and spout fittings 16′ of spout 10′ have an increased inner diameter.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A line system for a maple syrup production system having a mainline, comprising:
at least one spout having a spout fitting;
at least one lateral line fluidly connected to the main line via a mainline fitting;
at least one dropline fluidly connected at one end to the spout fitting and at another end to the lateral line at a lateral-line fitting; and
wherein the at least one lateral line has an inside diameter greater than 5/16″ nominal and less than or equal to ¾″, and the lateral line fitting and mainline fitting have a nominal inside diameter of greater than 0.225″ and less than or equal to 0.70″.

2. The line system of claim 1, wherein the at least one drop line has an inside diameter DI greater than 5/16″ nominal and less than or equal to ¾″, and the spout fitting has a nominal inside diameter of greater than 0.225″ and less than or equal to 0.70″.

3. The line system of claim 1, wherein the mainline fitting comprises a saddle connector.

4. The line system of claim 1, wherein the lateral line fitting comprises a T or a Y connector.

5. The line system of claim 1, wherein the spout includes an internal chamber.

6. A line system for a maple syrup production system having a mainline, comprising:
at least one spout having a spout fitting;
at least one lateral line fluidly connected to the main line via a mainline fitting;
at least one dropline fluidly connected at one end to the spout fitting and at another end to the lateral line at a lateral-line fitting; and
wherein the at least one drop line has an inside diameter greater than 5/16″ nominal and less than or equal to ¾″, and the lateral line fitting and spout fitting have a nominal inside diameter of greater than 0.225″ and less than or equal to 0.70″.

7. The line system of claim 5, wherein the spout includes an internal chamber.

8. A method of conveying sap from a taphole in a maple tree through a line system having a mainline attached to a vacuum system, comprising:
inserting a spout into the taphole, with the spout having a spout fitting;
fluidly connecting a dropline to the spout fitting;
fluidly connecting the dropline to a lateral line via a lateral line fitting;
fluidly connecting the lateral line to the mainline via a mainline fitting;
providing the lateral line with an inside diameter greater than 5/16″ nominal and less than or equal to ¾″;
providing the lateral line fitting and mainline fitting with a nominal inside diameter of greater than 0.225″ and less than or equal to 0.70″; and
applying a vacuum to the line system.

9. The method of claim 8, further comprising providing the drop line with an inside diameter greater than 5/16″ nominal and less than or equal to ¾″, and providing the spout fitting with a nominal inside diameter of greater than 0.225″ and less than or equal to 0.70″.

10. A method of conveying sap from a taphole in a maple tree through a line system having a mainline attached to a vacuum system, comprising:
inserting a spout into the taphole, with the spout having a spout fitting;
fluidly connecting a dropline to the spout fitting;
fluidly connecting the dropline to a lateral line via a lateral line fitting;
fluidly connecting the lateral line to the mainline via a mainline fitting;
providing the drop line with an inside diameter greater than 5/16″ nominal and less than or equal to ¾″; and
providing the lateral line fitting and spout fitting with a nominal inside diameter of greater than 0.225″ and less than or equal to 0.70″.

11. A line system for a maple syrup production system, comprising:
a spout having a spout fitting;
a dropline fluidly connected at one end to the spout fitting and at another end to a mainline at a mainline fitting; and
wherein the mainline has an inside diameter greater than 5/16″ nominal and less than or equal to ¾″, and the mainline fitting and spout fitting each have a nominal inside diameter of greater than 0.225″ and less than or equal to 0.70″.
